(19) United States
(12) Patent Application Publication
(10) Pub. No.: US 2026/0212203 A1
(43) Pub. Date: Jul. 23, 2026

(54) Query Engagement Context Multi-Task Multi-Label Learning

(71) Applicant: Google LLC, Mountain View, CA (US)

(72) Inventors: Gil Shamir, Sewickley, PA (US); Cheng Chen, Mountain View, CA (US)

(21) Appl. No.: 19/140,945

(22) PCT Filed: Dec. 20, 2022
(86) PCT No.: PCT/US2022/053436

§ 371 Date: Jun. 18, 2025

(51) Int. Cl. G06N 3/096; G06F 16/953

(52) U.S. Cl. CPC G06N 3/096; G06F 16/953

(57) ABSTRACT

Provided is a new set-wise optimization task that accounts for the effects of total labels of other (or all) items in a co-recommendation set on the individual predictions of item engagement rates. As one example, a training system can train a model to perform the proposed optimization task along with an individual engagement task and/or a ranking task in a multi-task training arrangement.

### FIELD

The present disclosure relates generally to machine learning. More particularly, the present disclosure relates to systems and methods for query engagement context multi-task multi-label learning.

### BACKGROUND

Various settings exist in which a computerized system endeavors to provide a set (e.g., an ordered list) of items as responses to a particular query. Examples of such systems include recommendation systems, information retrieval systems (e.g., search engines), and/or other systems. A query can be implicit (e.g., defined based on context) or explicit (e.g., defined based on specific natural language and/or image input (e.g., input by a user)). A query can be user-agnostic or user-specific.

As one example, recommendation systems provide lists of recommended items to a user in response to a user query. The user can then choose to ignore all recommendations, engage with one of the items, or engage multiple times with one or multiple items from the list provided in response to the query. Typically, engagement with one item in a recommendation set decreases the likelihood of engagement with the other items in the set. However, in some cases engagement with one item can imply higher likelihood of engagement with other items if a user is an engaging user. Typical massive-scale recommendation systems train individually on the items, and therefore do not directly account for these interactions. Certain ranking losses such as pairwise RankNet can account for feature interactions and for direct effects between two examples. However, these ranking losses do not directly account for the fact that the user actually engaged with multiple or other items in the set.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method for performing machine learning, the method comprising: obtaining, by a computing system comprising one or more computing devices, a training example comprising a plurality of items and a plurality of ground truth labels respectively associated with the plurality of items; respectively processing, by the computing system, each of the plurality of items with an item network of a machine learning model to generate a plurality of intermediate representations respectively associated with the plurality of items; collectively processing, by the computing system, the plurality of intermediate representations with a query network of the machine learning model to generate a set-wise label prediction collectively for the plurality of items, wherein the set-wise label prediction indicates a predicted aggregate value of the plurality of ground truth labels; and modifying, by the computing system, one or more parameters of the machine learning model based on a set-wise loss that generates a loss value based on the plurality of ground truth labels and the set-wise label prediction.

Another example aspect of the present disclosure is directed to a computer-implemented method for performing machine learning, the method comprising: obtaining, by a computing system comprising one or more computing devices, a training example comprising a plurality of items and a plurality of ground truth labels respectively associated with the plurality of items; and for one or more of the plurality of items: processing, by the computing system, data descriptive of the item with an item network of a machine learning model to generate an intermediate representation associated with the item; processing, by the computing system, the intermediate representation with a query network of the machine learning model to generate a set-wise label prediction for the item, wherein the set-wise label prediction indicates a predicted aggregate value of at least a subset of the plurality of ground truth labels; and modifying, by the computing system, one or more parameters of the machine learning model based on a set-wise loss that generates a loss value based on at least the subset of the plurality of ground truth labels and the set-wise label prediction.

Other aspects of the present disclosure are directed to various systems, apparatuses, non-transitory computer-readable media, user interfaces, and electronic devices. For example, a computer system can be configured to perform the methods described herein. For example, one or more non-transitory computer-readable media can store instructions that when executed by a computer system cause the computer system to perform the methods described herein. For example, a computer system can include a model that has been trained by performing the methods described herein. For example, one or more non-transitory computer-readable media can store a model that has been trained by performing the methods described herein.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example training scheme that includes a set-wise loss according to example embodiments of the present disclosure.

FIG. 2 depicts a block diagram of an example training scheme that includes a set-wise loss structured as an ordinal regression problem according to example embodiments of the present disclosure.

FIG. 3 depicts a block diagram of an example training scheme that includes a set-wise loss applied on a per-item basis according to example embodiments of the present disclosure.

FIG. 4 depicts a block diagram of an example training scheme that includes a set-wise loss applied on a per-item basis and limited to prior-sequenced items according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

Recommendation systems or other information retrieval systems such as search engines often show a set of recommended or suggested items to a user, where the user can engage with one or more of the items. These systems usually train a machine learning model to make predictions on a single task, which is the individual rate of engagement of a user with each respective recommended item. When better ranking is desired, multi-task training, including pairwise or listwise ranking losses can be applied to add the effects of co-recommendations on engagement rates. However, ranking-based approaches do not account for actual engagement by the user with a particular item and how that may affect the likelihood of a user engaging with another item.

In view of the above, the present disclosure introduces a new set-wise optimization task that accounts for the effects of total labels of other (or all) items in a co-recommendation set on the individual predictions of item engagement rates. As one example, a training system can train a model to perform the proposed optimization task along with an individual engagement task and/or a ranking task in a multi-task training arrangement.

The proposed set-wise (or query-level) optimization task can include training a model to predict a total count of engagements of a set of items (e.g., provided in response to a query), giving the model the ability to adjust the effects of multiple positive labels of co-recommended items on individual engagement predictions. As one example, multi-label ordinal regression can be used for the set-wise optimization task, and can be combined with individual label losses and/or ranking (among queries) label losses. However, other alternative approaches are possible, for example where positive engagement counts are predicted with ordinal regression as context information per impression, either for the full query or only for items positioned earlier in the recommendation set to the item considered.

More particularly, consider a training example that includes a plurality of items and a plurality of ground truth labels respectively associated with the plurality of items. Items can be any item potentially included in a list, such as items of content (e.g., webpages, images), movies, items of clothing or home goods, people, users, entities, locations, businesses, files, electronic mails, messages, advertisements, and/or any other items. The plurality of items may have been presented to a user and the ground truth label for each item may indicate if the user engaged with (e.g., clicked on, selected, purchased, etc.) the item.

In such a setting, if a particular item included in the set did not receive user engagement (e.g., has a zero-valued label), then the particular item is considered to be a negative example, lowering the predicted overall user engagement rate for the item. However, if a training scheme makes the model aware that other items in the co-recommended set did receive user engagement, then the model may attribute the lack of engagement with the particular item not to the prediction for the particular item, but instead to the presence of other items which did receive user engagement.

Thus, due to the additional information that other examples in the same set had user engagements, the model can decrease the negative effect of a negative label for the particular item in the co-recommended set on the individual predicted engagement rate of the particular example. Similarly, if an item in a co-recommended set has a positive engagement and there are multiple items with positive engagement in the set, then the model can further increase the individual predicted level of positive engagement for the item, because co-engagements are less likely. These relationships can be captured in training by using the set-wise or query-level training losses proposed herein which account for set-wise engagement interactions. However, in some implementations, at inference time, only the (modified) individual predicted engagement rates are used (as the model producing the individual predicted engagement rates has already been impacted at training by the additional information provided by the additional training task).

The proposed approaches give rise to the potential advantage of adding a set-wise loss to model training. Specifically, the model can be trained to predict a total number of set-wise engagements in response to a query. Using such a loss is conceptually different from ranking losses. While ranking losses usually push the prediction of a positive labeled example up, and those of negative examples down, adding the proposed loss would give the model the flexibility to adjust the predictions to the overall query response. Particularly, in the two examples described above, the proposed set-wise loss can prevent substantial decrease of the individual predicted engagement rate of an item with a negative label in a query with multiple engagements. Conversely, the proposed loss can result in an increase in the individual predicted engagement for an item with a positive label if the query had multiple engagements.

Example Training Schemes with Set-Wise Engagement Loss

Example implementations of the present disclosure can be applied in an online or batch system that trains a machine learning model, for example a deep network, to predict the probability of user engagement with items. As an example, an individual engagement training task can use binary logistic regression with logarithmic loss to train for individual engagement rates, where the model generates a score or other intermediate representation r_{qi} for example i in the q-th recommendation set in the training data. The score can be converted to a predicted probability of positive engagement with the logistic (Sigmoid) function, and the negative logarithm of the probability of the true label y_{qi}∈{0, 1} can be added to the loss. The model can be trained to minimize the logistic loss over all recommendation sets and items in all sets. The model can include other losses, such as ranking losses pairwise between items co-recommended in a set, or listwise among the list of items in the set. Other methods, such as distillation to the predictions of a more complex teacher model can also be applied. For ease of explication, the section describes the simplest setup, where a second per-query or set-wise task is now added to the system.

In particular, in addition to the individual engagement task described above, example implementations of the present disclosure can add a set-wise (or per-query or query-level) loss. For this loss the model can be tasked with generating a prediction that is a function of scores (or other intermediate representations) of some or all items in the same set. In particular, the model can be tasked with predicting the number of positive user engagements in the set as a whole.

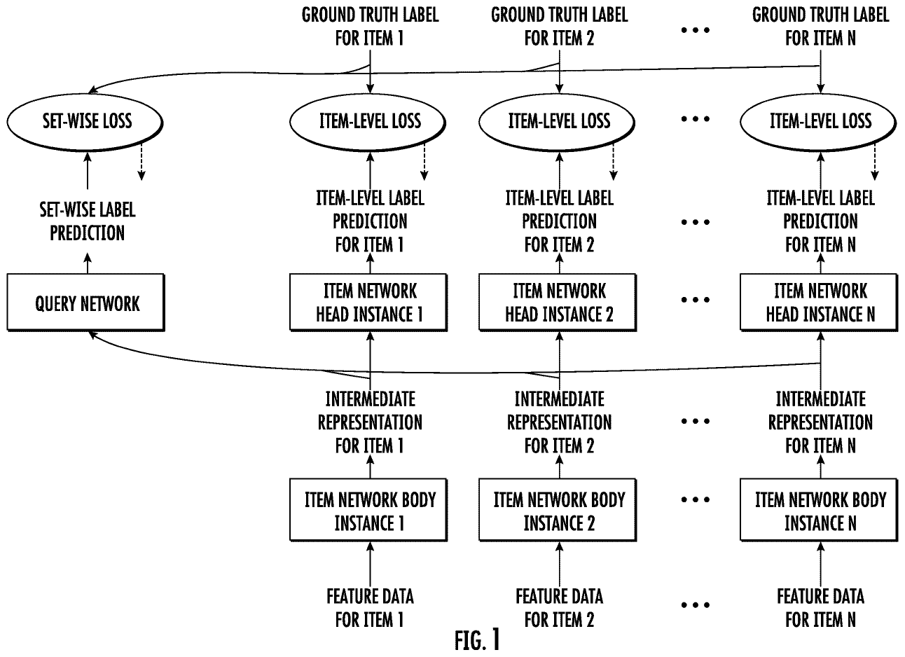

FIG. 1 depicts a block diagram of an example training scheme for a machine learning model that includes the proposed set-wise loss. In particular, FIG. 1 shows application of the training scheme to one training example. The approach can be repeated over any number of training examples included in a training dataset.

In particular, the training example can include a plurality of items and a plurality of ground truth labels respectively associated with the plurality of items. The plurality of items may have been presented (e.g., together as a set) to a user and the ground truth label for each item may indicate if the user engaged with (e.g., clicked on, selected, purchased, etc.) the item. As shown in FIG. 1, the training example can include N items.

As illustrated in FIG. 1, a respective instance of an item network body of the illustrated machine learning model can process feature data for each item to generate a respective intermediate representation for each item. The feature data for each item can be raw feature data or can be feature embeddings generated by a different model or otherwise previously generated in some fashion. The input to each instance of the item network can also include information about a query for which the items are candidate responses.

The item network body can, for example, be a feed-forward neural network or other form of neural network. However, the item network can also be some other form of machine learning model (e.g., including both linear and non-linear models). In some implementations, all instances the item network body and/or head share the same parameter values.

In some implementations, the intermediate representation for each item can be an embedding (e.g., a numerical vector) or other data retrieved from or output by a layer (e.g., a hidden layer) of the item network body. In some implementations, the intermediate representation for each item can be a logit score.

Referring still to FIG. 1, a respective instance of an item network head portion of the machine learning model can process the intermediate representation for each item to generate a respective item-level label prediction for the item. For example, the item-level label prediction for each item can be or correspond to a prediction of the individual engagement rate for that item. As one example, the item network head can be a softmax function or other output function or layer(s) to generate the item-level label prediction for each item from the intermediate representation for the item.

The training scheme can include respectively evaluating an item-level loss for each of the item-level label predictions. The item-level loss can generate a loss value for each item based on the item-level label predicted by the model for each item and the ground truth label for each item. The machine learning model can be trained based on each instance of the item-level loss. For example, the item-level loss can be backpropagated to update parameter values of the machine learning model. For example, each instance of the item-level loss can be backpropagated through the corresponding instance of the item network head and the corresponding instance of the item network body to update parameters of the item network head and/or body. In some implementations, the losses can also be used to update the weights of the input features, or their embeddings.

In addition, according to an aspect of the present disclosure, a query network portion of the machine learning model can collectively process some or all of the intermediate representations generated for the N items to generate a set-wise label prediction for the item. The set-wise label prediction can be a prediction of an aggregate value (e.g., sum) of the ground truth labels for the items for which the query network received intermediate representations (e.g., which may be all N items). The query network can, for example, be a feed-forward neural network or other form of neural network. However, the query network can also be some other form of machine learning model (e.g., including both linear and non-linear models).

The training scheme can include evaluating a set-wise loss that generates a loss value based on the plurality of ground truth labels and the set-wise label prediction. The machine learning model can be trained based on the set-wise loss. For example, the set-wise loss can be backpropagated through the query network to update parameter values of the query network. Furthermore, the set-wise loss can be further backpropagated through some or all of the instances of the item network body that generated intermediate representations that were supplied to the query network. In some implementations, the loss can also be used to update the weights of the input features, or their embeddings.

For the set-wise loss, one option is to use Poisson regression or some other continuous-valued regression approaches to predict an uncapped number of engagements from 0 or above in response to the recommendation set. Thus, in some implementations, the set-wise label prediction is a continuous-valued regression prediction.

However, in many systems, a large number of engagements in response to a set are not expected. Therefore, some example implementations can cap the number of engagements predicted to the set {0, 1, . . . , L−1} for some finite L. This enables framing the proposed set-wise task as a multi-class prediction problem, where the role of the proposed set-wise task is to generate the probability of the number of engagements with the set as a whole. The L labels correspond to the set-wise engagement counts. Thus, in some implementations, the set-wise label prediction is a multi-label prediction.

Because there is a clear ordering among the labels, which is relevant to the optimization, this problem can optionally be optimized as an Ordinal Regression problem. For example, instead of solving a Softmax multi-label classification problem using logistic regression, example implementations can solve the problem as an ordinal regression multi-class classification problem so as to retain ordering. However, the proposed task can also be structured as a Softmax-based multi-label classification problem using logistic regression. Thus, in some implementations, the set-wise label prediction is a multi-label ordinal regression prediction.

In either of the general multi-label or the multi-label ordinal regression settings described above, the set-wise loss can compare the set-wise label prediction to a label set generated based on a sum of the plurality of ground truth labels. As one example, for the general multi-label setting, assuming there are six potential labels corresponding to zero to five engagements, and a sum of the plurality of ground truth labels equals three, then the following label set can be generated {0,0,0,1,0,0}. As another example, as will be discussed further below, for the ordinal regression setting, assuming there are six potential labels corresponding to zero to five engagements, and a sum of the plurality of ground truth labels equals three, then the following label set can be generated {0,0,0,1,1,1}.

### Example Ordinal Regression on Query Recommendation Sets

This section describes example implementations which structure the set-wise task as an ordinal regression problem. There are different methods to optimize multi-label loss with ordinal regression. One example approach breaks the problem into L−1 binary logistic regression problems optimizing all points on the Cumulative Density Function (CDF) of the label set. This section reviews this approach for completeness. Let the score vector for query q be denoted by s_{q}. It consists of L−1 values, l∈{0, 1, . . . , L−2}, which are binary logit values of the points of the CDF predicted for the query labels z_{q} of query q, given by:

$${s}_{q ℓ} \hat{=} log \frac{Pr ( {z}_{q} \leq ℓ )}{Pr ( {z}_{q} > ℓ )} = log \frac{Pr ( {z}_{q} \leq ℓ )}{1 - Pr ( {z}_{q} \leq ℓ )} . \qquad ( 1 )$$

We can define:

$${p}_{q ℓ} \hat{=} Pr ( {z}_{q} \leq ℓ ) . \qquad ( 2 )$$

The model trains L−1 binary logistic regression losses over the query sets, where the 1-th one matches the objective of the CDF at label l. The label for the 1-th model is in {0, 1}, taking value 1 if z_{q}≤1, and value 0, otherwise. For example, if L=10, and z_{q}=6, then, an example approach trains 9 logistic regression losses where the labels are {0, 0, 0, 0, 0, 0, 1, 1, 1}. For z_{q}=3, the labels are {0, 0, 0, 1, 1, 1, 1, 1, 1}.

With deep networks, such a set of models can train with a single network, with L−1 query outputs. All input feature vectors can feed into networks of each of the items in the recommendation set, and then aggregated into L−1 network outputs for the query. For each of the L−1 outputs, a different label loss can be applied taking the labels from the vector of labels as described above. The structure of the output layer can be identical to that of a Softmax loss, but instead of applying a single softmax cross entropy loss on all L (or L−1) outputs, each of the L−1 outputs has its own binary logistic regression loss. One example set-wise loss applied to the l-th output for the q-th query is then:

$${L}_{q ℓ} = - I ( {z}_{q} \leq ℓ ) log {p}_{q ℓ} - I ( {z}_{q} > ℓ ) log ( 1 - {p}_{q ℓ} ) \qquad ( 3 )$$

where I(.) is the indicator function. For each 1, the loss can be aggregated (summed) over all Q queries in the training dataset. The query label probability mass function (PMF) learned gives label 1 probability which is the difference between its CDF and that of l−1,

$$Pr ( {z}_{q} = ℓ ) = {p}_{q ℓ} - {p}_{q ; ℓ - 1} \qquad ( 4 )$$

where P_{q;-1}=0, and P_{q;L-1}=1. Because some example implementations only use this loss to train and adjust prediction credit of individual items so that the effects of positive engagements on other co-recommended items adjust predictions, and because example implementations do not need to actually generate a prediction for the number of positive engagements in the query, equation (4) does not necessarily need to be used. Instead, the losses of (3) can be applied in training after generating binary labels from the actual number of positive engagements z_{q} in the query.

This formulation of the loss does not guarantee that the learned probability of each label is positive. Additional constraints or regularization capping movements of logit scores can optionally be applied to guarantee nonnegative label probabilities. However, because some example implementations do not need to use the actual probability in equation (4), this problem can optionally be ignored with the CDF implementation of ordinal regression optimization.

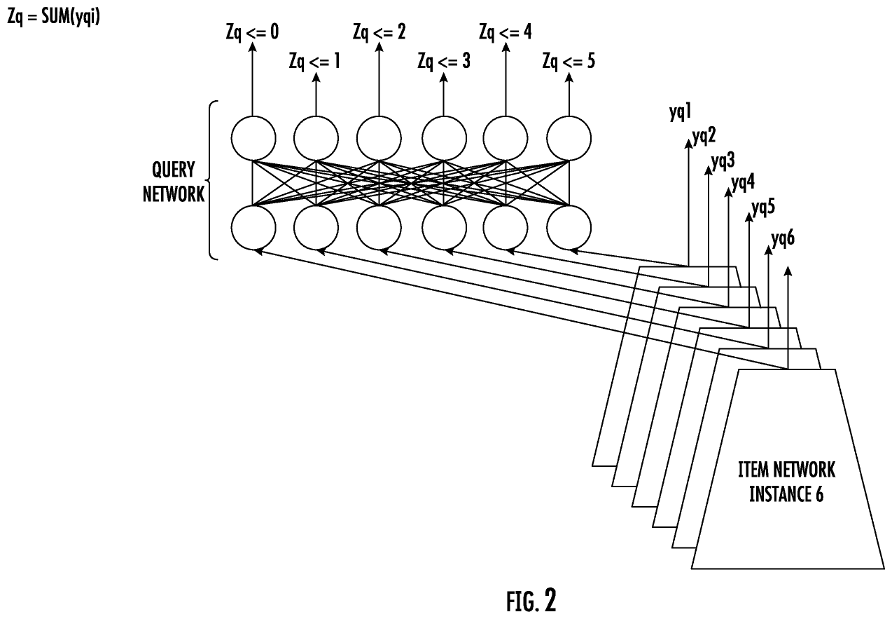

FIG. 2 depicts an example of a training system applying the ordinal regression-based approach for a single query with a set of recommendation items. Each item label (y_{q1}, . . . y_{q6}) where y_{qi}∈{0, 1} is predicted from the item network. The item networks can have the same weights and biases, but may have different inputs that can, for example, be feature embedding vectors. Typically, inputs may contain a subset of query features or feature embeddings that are shared among all items in the query, and thus repeated as inputs to the different item networks.

A signal from a hidden layer (e.g., the penultimate layer) of each of the item networks is propagated into a query network (which may include one or more layers). This query network produces L−1 predictions, predicting the CDF values for query labels {0, 1, . . . , L−2}. The query label z_{q} is the sum of the item labels. Gradients of loss applied on each of the CDF predictions and on the individual item labels can propagate in training to update the weights of all layers (e.g., layers of both the query network and the item network). In some implementations, the losses can also be used to update the weights of the input features, or their embeddings. Some weights can be used to balance between the set-wise losses and the item-level losses as described next.

### Example Combined Training Losses

Combining the standard per-example logistic loss with the per-query recommendation set ordinal regression CDF loss, where we use a parameter alpha in [0,1] to balance between the losses, the total training loss is

$$\begin{matrix}L = ( 1 - α ) {\sum }_{q = 1}^{Q} \text{?} \{ I ( {y}_{qi} = 1 ) log ( 1 + \text{?} ) + I ( {y}_{qi} = 0 ) log ( 1 + \text{?} ) \} \\ + α {\sum }_{q = 1}^{Q} {\sum }_{ℓ = 0}^{L - 2} \{ I ( {z}_{q} \leq ℓ ) log ( 1 + \text{?} ) + I ( {z}_{q} > ℓ ) log ( 1 + \text{?} ) \}\end{matrix} \qquad ( 5 )$$

$$\text{?} \text{indicates text missing or illegible when filed}$$

where N_{q} is the number of items included in the same set provided in response to query q, and Q is the number of queries in the training dataset. The first double sum accounts for the regular logistic regression individual engagement loss, and the second for the per query ordinal regression multi-label CDF based loss.

Equation (5) represents one example loss form based on the CDF of ordinal regression optimization. However, other implementations can be used additionally or alternatively. These include the relaxed form of ordinal regression that constrains the solution to be governed by fewer parameters than the more general form considered above. A conditional form of the solution can also be used. Such a form guarantees nonnegative label probabilities.

### Example Ranking Loss Among Recommendation Sets

Ranking losses can also be represented using ordinal regression on items co-recommended in the same set. Ranking loss, however, can also be applied across different sets. If this is done, it enhances differences between items with different labels. In the present disclosure, ordinal regression can be applied on a label of a query. There are generally no co-recommended queries. However, some example implementations can use a ranking loss to enhance differences among queries with different positive count labels. Using a pairwise ranking loss, a ranking loss can be applied among multiple queries in the same training batch, either on all pairs with different labels in the batch, or on a subset (e.g., randomly selected) of such queries.

### Example Distillation

As with simple binary logistic regression models, a more expensive teacher model can be trained on more data. Then, the model used for inference can be a simpler one and train fast on a smaller training set. Distillation of predictions of the teacher model can be used to improve predictions of the student model which is used for inference. Distillation can be applied on each binary logistic regression component of the model described in FIG. 2. Distillation can treat each of the binary prediction tasks (each point in the ordinal CDF and the per item individual predictions) as a separate binary task and apply standard binary distillation losses as well as ranking distillation losses to improve the prediction of the student model. In some implementations the query network can be viewed or treated as a teacher network and the training scheme can include performing distillation training to train a student network to predict the set-wise label prediction output by the teacher network. In other implementations, distillation can be applied either on the per item objective shown in FIG. 2 or on the per-query objective, shown in FIG. 2, or on both.

### Example Alternatives and Related Per-Item Methods

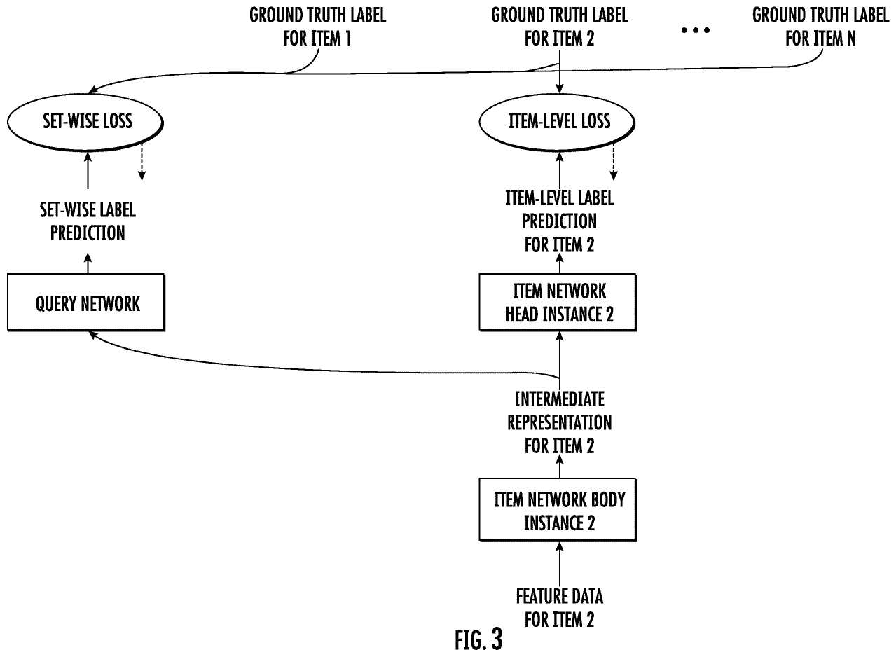

In FIGS. 1 and 2 and equation (5) the set-wise (or per-query) optimization is done with a single loss on all the items in the set at a per-query level—one loss for the whole query. Instead, some example implementations can train the set-wise label per item. Each item in the recommendation will then train on two tasks (with two outputs), one is its regular label loss task, and the other is the set-wise count task, which can still be trained with ordinal regression or other approaches as described above. This approach decouples the items in the recommendation set from each other, but still uses the positive engagement count in the set as a context label. An example illustration of this approach is shown in FIG. 3, applied to item 2 as an example. The approach shown in FIG. 3 can be applied to all items in a query set on a per-item basis (and to all queries in a training dataset as well).

Thus, gradients of the same label will not propagate to different networks, but shared query feature inputs as well as shared hidden layer parameters will still be updated by all items in a query recommendation set. Specifically, define s_{{qil}} as the logit for query q, item i in query q, and the CDF for label l. The logits s_{{qil}} attempt to learn the same score for every i in the query q, but each is trained on the network of item i. The second term of the loss in (5) will now have an additional sum over the items in the set, and s_{{qil}} replaces s_{{ql}} in the sum, giving the loss

$$\begin{matrix}L = ( 1 - α ) {\sum }_{q = 1}^{Q} \text{?} \{ I ( {y}_{qi} = 1 ) log ( 1 + \text{?} ) + I ( {y}_{qi} = 0 ) log ( 1 + \text{?} ) \} \\ + α {\sum }_{q = 1}^{Q} {\sum }_{i = 1}^{{N}_{q}} {\sum }_{ℓ = 0}^{L - 2} \{ I ( {z}_{q} \leq ℓ ) log ( 1 + \text{?} ) + I ( {z}_{q} > ℓ ) log ( 1 + \text{?} ) \} .\end{matrix} \qquad ( 6 )$$

$$\text{?} \text{indicates text missing or illegible when filed}$$

It may be simpler to implement this approach, as it does not require connecting between the different examples and propagating gradients across example boundaries, only using the same query count label across the recommendation set. Again, ranking losses and distillation can still be used in a similar manner as described.

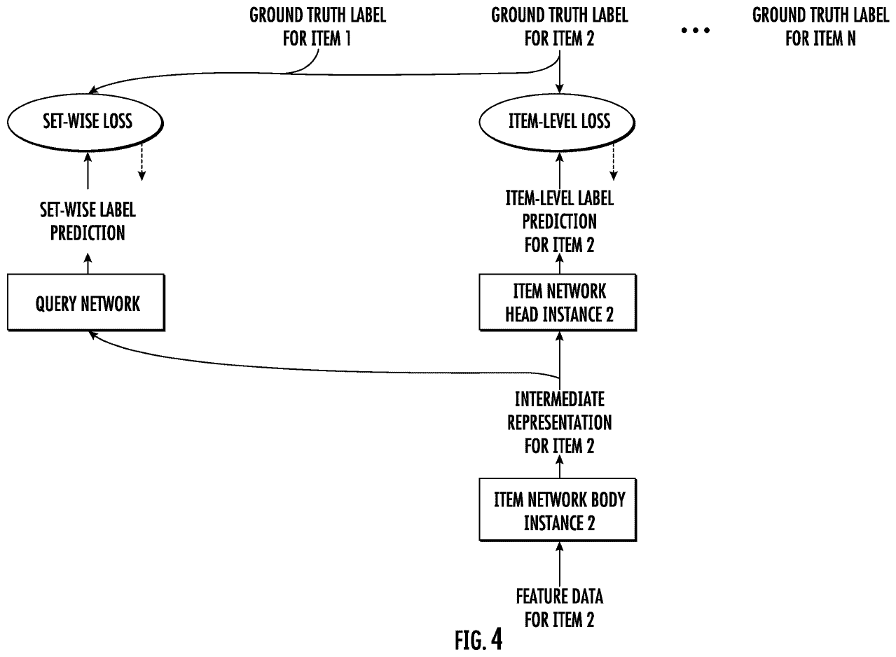

Taking the per item approach further, instead of or in addition to learning the total query positive engagement count, some example implementations can optimize the model on the engagement count of all items which are in better positions than the item we optimize (e.g., items that are more prominently displayed or otherwise presented to the user prior to the item). An example of illustration of this approach is shown in FIG. 4 as applied to item 2. In the illustrated example, the ground truth label for item 1 is provided to the set-wise loss because it was in a better position than item 2, but labels for items 3 or greater are not provided to the set-wise loss.

Information about items in better positions is specifically important, because if engagement takes place with an item in a better position, it is very likely to reduce engagement rate of an item ranked lower. Training the model on this count signal can reduce the penalty on an item with negative engagement, which is in a worse position than an item with a positive engagement. This approach can therefore guide the model to attribute the negative engagement to the relative positioning of the item instead of the individual item engagement rate. The labels of the second sum of equation (6) in this case will change to per-item labels, which count the context of positive engagements of items in positions preceding the position of the item. Because the labels of the items in the recommendation set are now different, adding a ranking loss for items in the query may also be beneficial to enhance differences in position boundaries in which the engagement rates increase, enhancing the credit for positive engagements of items in lower positions.

### Example Devices and Systems

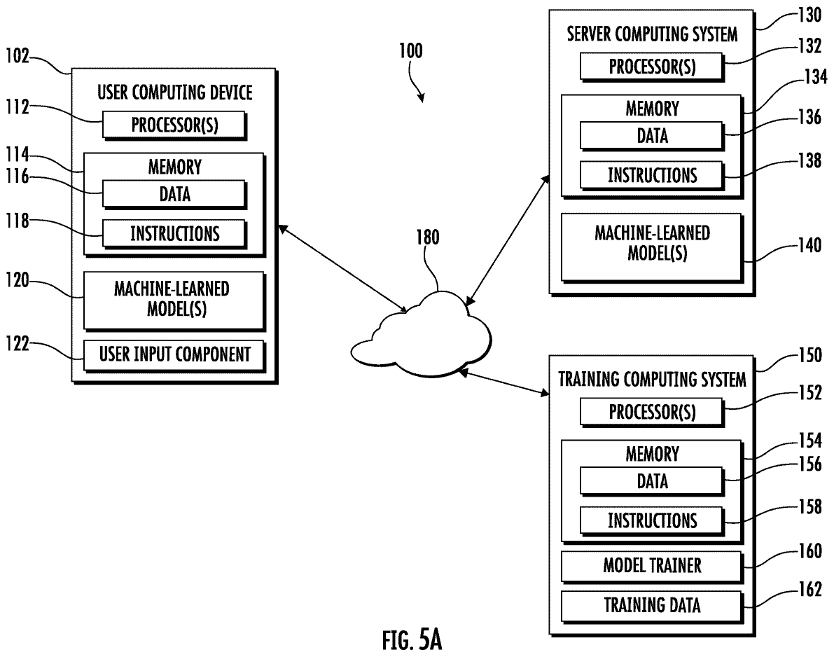

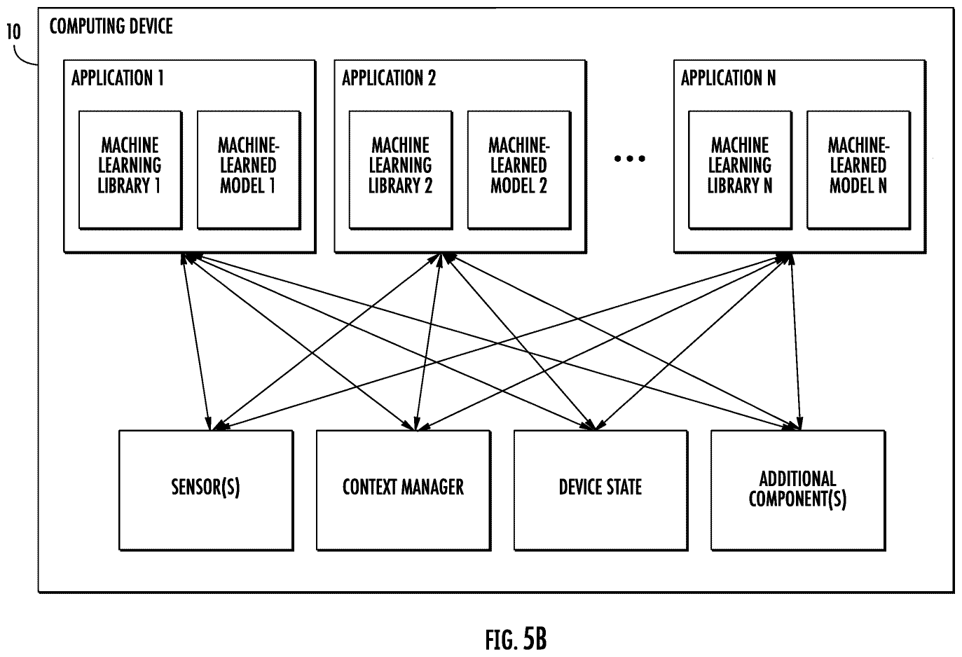

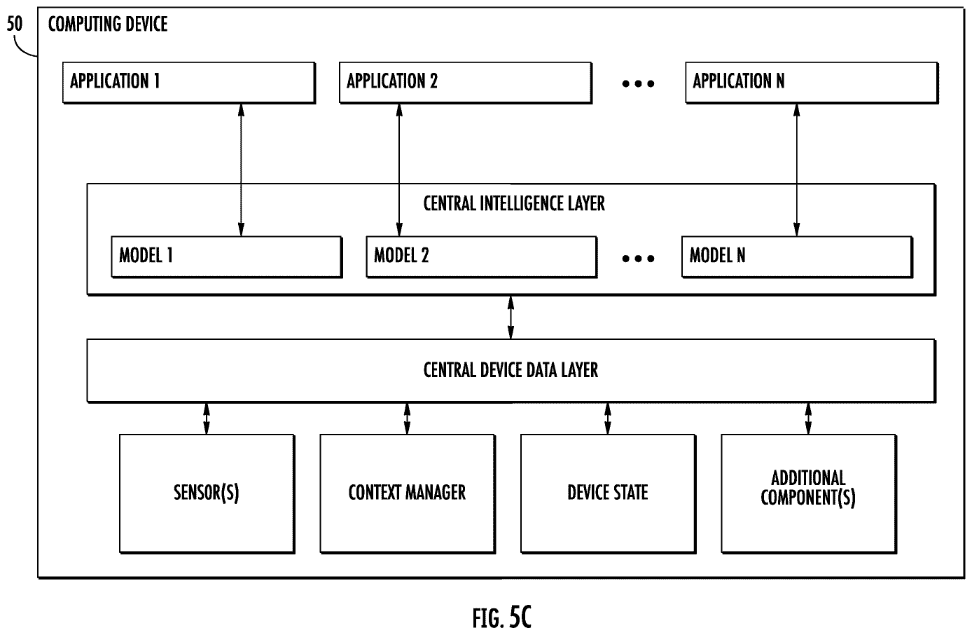

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an information retrieval service such as a recommendation system or a search engine). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, a plurality of training examples. For example, each training example can include a plurality of items and a plurality of labels respectively associated with the plurality of items.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for performing machine learning, the method comprising:
obtaining, by a computing system comprising one or more computing devices, a training example comprising a plurality of items and a plurality of ground truth labels respectively associated with the plurality of items;
respectively processing, by the computing system, each of the plurality of items with an item network of a machine learning model to generate a plurality of intermediate representations respectively associated with the plurality of items;
collectively processing, by the computing system, the plurality of intermediate representations with a query network of the machine learning model to generate a set-wise label prediction collectively for the plurality of items, wherein the set-wise label prediction indicates a predicted aggregate value of the plurality of ground truth labels; and
modifying, by the computing system, one or more parameters of the machine learning model based on a set-wise loss that generates a loss value based on the plurality of ground truth labels and the set-wise label prediction.

2. The computer-implemented method of claim 1, wherein the set-wise label prediction comprises a continuous-valued regression prediction.

3. The computer-implemented method of claim 1, wherein the set-wise label prediction comprises a multi-label prediction.

4. The computer-implemented method of claim 1, wherein the set-wise label prediction comprises a multi-label ordinal regression prediction.

5. The computer-implemented method of claim 3, wherein the set-wise loss compares the set-wise label prediction to a label set generated based on a sum of the plurality of ground truth labels.

6. The computer-implemented method of claim 1, wherein modifying, by the computing system, one or more parameters of the machine learning model based on the set-wise loss comprises modifying, by the computing system, one or more parameters of the item network based on the set-wise loss.

7. The computer-implemented method of claim 1, wherein the plurality of intermediate representations comprise a plurality of logit scores generated for an individual engagement score task.

8. The computer-implemented method of claim 1, wherein the method further comprises:
respectively processing, by the computing system, each intermediate representation to generate a plurality of item-level label predictions respectively associated with the plurality of items;
modifying, by the computing system, one or more parameters of the machine learning model based on an item-level loss that generates a loss value for each item based on the item-level label for each item and the ground truth label for each item.

9. The computer-implemented method of claim 8, wherein the item-level loss comprises a ranking loss.

10. The computer-implemented method of claim 1, wherein the query network comprises a teacher network and wherein the method further comprises performing distillation training to train a student network to predict the set-wise label prediction output by the teacher network.

11. The computer-implemented method of claim 1, wherein the set-wise loss comprises a ranking loss.

12. The computer-implemented method of claim 1, wherein, the set-wise loss comprises a softmax prediction loss, ordinal regression optimization, or a constrained form of ordinal regression training.

13. A computer-implemented method for performing machine learning, the method comprising:
obtaining, by a computing system comprising one or more computing devices, a training example comprising a plurality of items and a plurality of ground truth labels respectively associated with the plurality of items; and
for one or more of the plurality of items:
processing, by the computing system, data descriptive of the item with an item network of a machine learning model to generate an intermediate representation associated with the item;
processing, by the computing system, the intermediate representation with a query network of the machine learning model to generate a set-wise label prediction for the item, wherein the set-wise label prediction indicates a predicted aggregate value of at least a subset of the plurality of ground truth labels; and
modifying, by the computing system, one or more parameters of the machine learning model based on a set-wise loss that generates a loss value based on at least the subset of the plurality of ground truth labels and the set-wise label prediction.

14. The computer-implemented method of claim 13, wherein the at least the subset of the plurality of ground truth labels comprises all of the plurality of ground truth labels.

15. The computer-implemented method of claim 13, wherein, for each of the one or more of the plurality of items, the at least the subset of the plurality of ground truth labels comprises the ground truth labels for items which precede the item in a sequential ordering of the plurality of items.
